(19) United States
(12) Patent Application Publication
(10) Pub. No.: US 2007/0156653 A1
(43) Pub. Date: Jul. 5, 2007

(54) Automated knowledge management system

(76) Inventor: Manish Garg, Sunnyvale, CA (US)

Correspondence Address: SAP/BLAKELY, 12400 WILSHIRE BOULEVARD, SEVENTH FLOOR, LOS ANGELES, CA, 90025-1030, US

(21) Appl. No.: 11/322,963

(22) Filed: Dec. 30, 2005

(51) Int. Cl. G06F 17/30

(52) U.S. Cl. 707/3

(57) ABSTRACT

A knowledge management system includes a data recognition engine that dynamically defines metadata to be extracted from a plurality of data sources. A data collection engine is coupled to the data recognition engine to detect and extract the metadata from the plurality of data sources, and a data analysis engine is coupled to the data recognition and data collection engines to link metadata collected from the data collection engine. A search engine is coupled to the data analysis engine to receive output from the data analysis engine.

### FIELD OF THE INVENTION

The field of invention relates generally to information systems. In particular, the invention relates to an automated knowledge management system.

### BACKGROUND

A hierarchy of information may be thought of as comprising four layers: data, information, knowledge, and wisdom. Each layer adds certain attributes over and above the previous one. Data is the most basic level; information adds context, that is, circumstances and conditions which surround the data; knowledge adds how to use the data; and wisdom adds when to use the data.

The hierarchical model may be used as an aid to research and analysis by applying the following chain of actions. Data is gathered and/or exists the form of raw observations, measurements, and facts. Information is created by analysing relationships and connections between the data. Information is capable of providing simple answers to who/what/where/when/why type questions. Information may be provided to an audience and has a purpose. Knowledge is created by using the information to perform some action. Knowledge is capable of providing an answer to the question how. Knowledge may be a local practice or relationship that is successful. Wisdom is created through use of knowledge, through the communication of knowledge users, and through reflection. Wisdom answers the questions why and when as they relate to actions. Wisdom takes implications and effects into account.

A model such as described above is used primarily in the fields of information science and knowledge management. Knowledge management exists as an intuitive process, e.g., apprenticeships, or coworkers or colleagues having a discussion. With advances in technology, the biggest challenge today is the scope and speed by which knowledge can be created, accessed and exchanged. The goal of knowledge management is to provide real-world explanations and best practices for individuals and companies seeking to harness their knowledge potential.

There are several types of knowledge relevant to an organization. Nonaka and Takeuchi (Nonaka, I. and Takeuchi, H. (1995). The Knowledge Creating Company, New York: Oxford University Press.) suggest separating the concepts of data, information, tacit knowledge and explicit knowledge. Data is factual, raw material and therefore without information attached. Information is refined into a structural form, e.g. client databases. Explicit knowledge relates to knowing about information, and can be written and easily transferred. This category of knowledge may include manuals, specialized databases, collections of case law, standardized processes or protocols, or templates for documents. A key attribute of explicit knowledge is the possibility to store it. Tacit knowledge relates to knowing how to best use information or understanding information and cannot be directly transferred between individuals; it is transferred through application, practice and human interaction.

Organizational knowledge management is the creation, organization, sharing and flow of knowledge in organizations. The field of knowledge management attempts to make the best use of the knowledge that is available to an organization, creating new knowledge, increasing awareness and understanding in the processes of the organization.

Knowledge management can also be defined as the capturing, organizing, and storing of knowledge and experiences of individual workers and groups within an organization and making this information available to others in the organization. As organizations expand globally, this process of capturing, organizing and storing knowledge becomes more challenging—it becomes more difficult to locate experts in a particular knowledge domain. Commonly, individuals tend to build their own networks and search for experts by “asking around”. This process of seeking out an appropriate expert could take several days before the expert is located.

Organizations try to capture knowledge by creating knowledge repositories. However, these repositories more often serve merely as information repositories. Moreover, knowledge repositories suffer the fact that information/data typically is not up to date, is difficult to search and therefore not very helpful, require active user inputs, which means lots of information is lost in the process, and often there context is missing because an entire data set is not captured.

### SUMMARY

A knowledge management system comprises a data recognition engine to define metadata to be extracted from a plurality of data sources, a data collection engine coupled to the data recognition engine to detect and extract the metadata from the plurality of data sources; a data analysis engine coupled to the data recognition and data collection engines to link metadata collected from the data collection engine; and a search engine coupled to the data analysis engine to receive output from the data analysis engine.

### BRIEF DESCRIPTION OF THE DRAWINGS

A better understanding of the present invention can be obtained from the following detailed description in conjunction with the following drawings, in which:

FIG. 1 illustrates an embodiment of the invention; and

FIG. 2 illustrates an embodiment of the invention.

### DETAILED DESCRIPTION

Overview

To effectively harness knowledge, one embodiment of the invention contemplates a passive knowledge tracking system (PKTS, or simply KTS) that tracks and extracts useful information. For example, based on an individual's day to day activity, the KTS can recognize and formulate a knowledge domain on which an individual is an expert. The tracking can be based on computer and network-based systems used by the individual (e.g., electronic mail (“email”), developer or collaboration networks, electronic forums or workgroups, databases, spreadsheets, presentations, documents, user guides/references, etc). As an example, if an individual is a software programmer, then program code repositories accessed by the individual may be passively tapped by the KTS.

Heuristics, that is, techniques for discovery, can be applied to extract and connect data from heterogeneous systems. For example, data extracted from code repositories and a human resources (HR) system can be related to each other in meaningful ways. If a code repository is scanned, the following details of an individual may be extracted:
Programmer's name, identification number, email address, etc.;
Software module(s) that (s)he is developing or has developed
Underlying technologies used (e.g., based on software libraries accessed)
Identification of programmers that are contributing to the software module(s).

Details about software libraries may be further inferred based on the data from system landscape scenario descriptions. A system landscape scenario description provides a description of what a library contains, what it means, what it is used for. The description may be stored in a configuration file, or a “Jar” file. In computing environments, a Jar file is a Java programming language based archive file, typically a ZIP file, that is used to store and distribute compiled Java classes and associated metadata that may constitute a program. OpenDocument files are also Java archives which store XML files and other objects. Jar files can be created and extracted using the “jar” command that comes with the Java Developer's Kit (JDK). Alternatively a Jar file can be created using zip tools. A jar file has a manifest file with entries that determine how the jar file will be used.

Metadata is simply data about data, that is, information that describes another set of data. Metadata may include a description of contents of the data set, its location, the source or author of the dataset, how the dataset should be accessed, and its limitations. Metadata may be termed an ontology or schema when structured into a hierarchical arrangement. Regardless of the term used, metadata describes what exists for some purpose or to enable some action.

HR systems can be used to infer more details about the teams of individuals working on certain projects. Therefore, if a person is not interacting with a system being tracked by the KTS, but is still part of a team, (s)he is included in the heuristics. For example, a software system architect might not be using a programming code repository, but is still informed about the project.

Architectural Overview

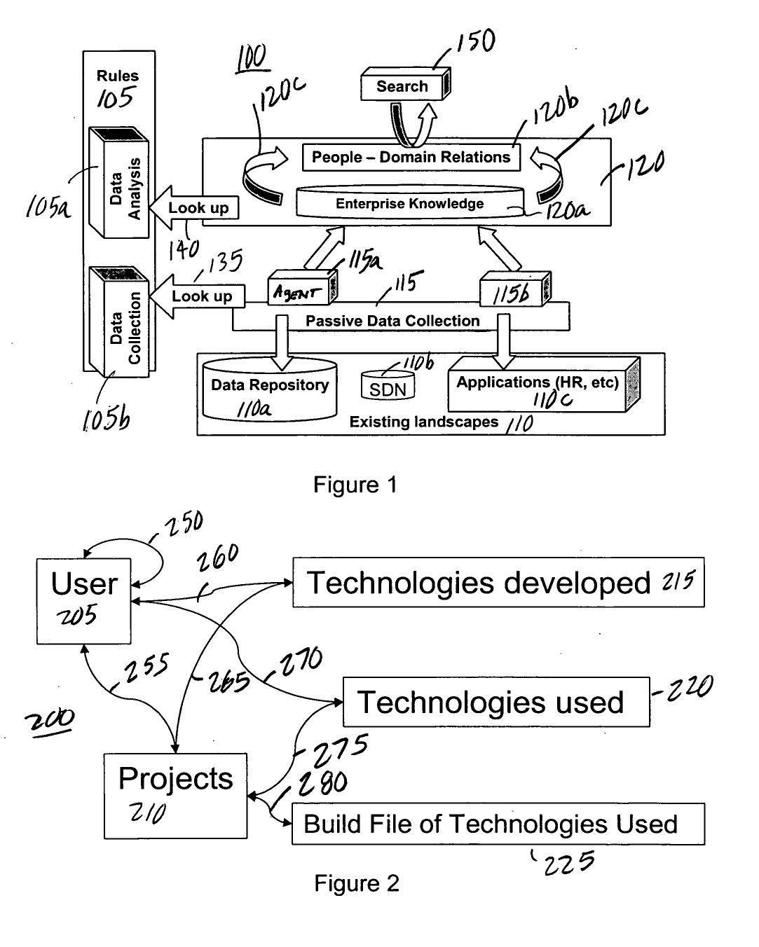

With reference to FIG. 1, a knowledge tracking system may be divided into four parts: data recognition; data collection; data storage and data organization; and data retrieval and presentation. Data recognition is driven by data collection rules 105b, which are configured and managed by a rules engine 105. The rules engine provides for user input to define the rules for collection of data, among other things. The data collection rules determine what data should be passively extracted from which system in a set of existing landscapes 110. For example, if data is being retrieved from a data or code repository 110a, a software developers network (110a), or electronic systems such as a human resources (HR) application 110c, data collection agents 115a, 115b extract data such as user names, libraries used, etc, based on the rules for such collection. This data may be actual data, but more commonly is metadata to be used by the data analysis engine to establish relationships among the disparate data.

Once the system 100 knows what data to collect, a data collection engine driven by multiple agents queries the underlying systems and collects the data. In some cases, there may be enormous amounts of data requiring data to be retrieved in batches. In one embodiment, there are specific data collection agents for each of the data sources or types of data sources.

As an example, the KTS in one embodiment of the invention extracts data from a code repository 110a, such as DTR or Perforce to extract relations between software developers and libraries (i.e., technology) used by them. Further extracted is information such as relevancy by time and other developers connected to a particular topic or project in the repository. Perforce is a Revision Control (RC) system developed by Perforce Software, Inc. and is based on a client/server model with the server managing a collection of source program code versions in a depot.

Another code repository is the Design Time Repository (DTR) that provides file versioning, available from SAP AG, the assignee of this invention. With DTR, all design time objects or sources are stored and versioned centrally. It is used at SAP's customers' and partners' sites as well as in SAP's own development. The DTR provides mechanisms for managing large-scale multi-user Java application development that is distributed across geographical locations; it is based on access via files and folders. It supports development landscapes with multiple repositories, where resources and changes can be propagated between these repositories.

A software developer's network (SDN) may be tracked by one or more agents in the KTS to extract users associated with certain topics, or user forums. The keywords are already created and maintained by the SDN and are used during search operations therein, rendering them easily extracted by an agent 115 in one embodiment of the invention. Likewise, systems 110c, such as an HR system, provide for creation of a user hierarchy and formation of a group of users. Finally, the collection engine may extract a system landscape directory, for example, to translate the meaning of libraries used in the landscape.

The third element of a KTS system, data storage and data organization, follows next. Once relevant data is collected, data analysis rules, maintained at 105a by rules engine 105, provide input to a data organization engine 120 to manipulate and modify the data so that data from disparate systems is collated and linked together. For example, metadata at 120a, spanning an organization's enterprise, is extracted at 115, and linked at 120c to form a relationship with metadata that identifies individuals that are experts in a particular knowledge domain, at 120b. Indexes for later searching the KTS may also be generated at this stage. In one embodiment of the invention, existing indexing engines may be used to index the data, for example, the software developers network 110b may comprise a search routine based on keywords maintained in a list by the SDN.

As the last element of the KTS system, data retrieval and presentation, the data, now organized and ready to be searched, may be queried by a search engine at 150. In one embodiment of the invention, existing search technologies may be used to perform searching.

In one embodiment of the system, to provide for scalability, relevancy and timeliness of the data, a rule based lookup mechanism is required. As illustrated in the embodiment depicted in FIG. 1, rule lookup is implemented at two separate layers, 135 and 140. The first layer of rules is applied at 135 as part of the data collection or extraction stage. The rules may well be dependent on the type of system that is being searched (DTR, HR, etc.) The rules maintain the relations between the data in the specific system. A second layer, or set, of rules is maintained and applied at 150 as part of the data analysis layer driven by engine 120. At this layer, the extracted data may be grouped in to a well defined relation of objects.

FIG. 2 illustrates sample relations that can be derived from an embodiment of the invention. As can be seen, individuals, e.g., users, represented by a block at 205, may be related to one another (denoted by a link 250 which loops back to the block “users”). For example, a user may have a relationship with other users, such as other individuals with whom the user is collaborating on a project. A user may have a relationship with as well with one or more projects 210 (denoted by link 255). Additionally, the analysis engine may form relationships between users and technologies developed 215 (as denoted by link 260) and between users and technologies used 220 (denoted by link 270). Likewise, relationships may be created between projects 210 and technologies developed 215 (see link 265), and between projects and technologies used 220 (see link 275). Indirect links may exist as well. For example, a user may work on a project 210 and the projects deliverables is a developed technology at 215. The user in this instance has a contextual relationship with both, and the inputs to generate certain outputs are listed as technologies used at 225

The data analysis rules 105a may also define the strength of a relation. For example, a users' relation with another data element may be associated with the date—more recent relations may be treated as stronger or more relevant than less recent relations. In one embodiment, this type of analysis may be performed based on the number of connections a user has to a context of information and how recent are those connections. The following example illustrates the user-context strength calculation.

If program source code repositories 110a are searched and the system determines that a user has worked on 80 percent of the files searched in a certain software program module, and most of these files were searched recently (e.g., within the last x number of days, wherein x is obtained from the rules definition), then the user has a relatively strong contextual relation that module. Similar information can be extracted from other data sources, such as the developers network 110b—the system determines on which topics a user is most involved in and in what capacity, whether the user is searching for certain topics, solving problems on a forum, or merely posting questions on the forum. Based on this information, the KTS identifies a user relation with certain topics and may tag users as experts, if the contextual relation is strong, wherein strong is defined by some threshold.

Processes taught by the discussion above may be performed with program code such as machine-executable instructions which cause a machine (such as a “virtual machine”, a general-purpose processor disposed on a semiconductor chip or special-purpose processor disposed on a semiconductor chip) to perform certain functions. Alternatively, these functions may be performed by specific hardware components that contain hardwired logic for performing the functions, or by any combination of programmed computer components and custom hardware components.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

A computing system can execute program code stored by an article of manufacture. The applicable article of manufacture may include one or more fixed components (such as a hard disk drive or memory) and/or various movable components such as a CD ROM, a compact disc, a magnetic tape, etc. In order to execute the program code, typically instructions of the program code are loaded into the Random Access Memory (RAM); and, the processing core then executes the instructions. The processing core may include one or more processors and a memory controller function. A virtual machine or “interpreter” (e.g., a Java Virtual Machine) may run on top of the processing core (architecturally speaking) in order to convert abstract code (e.g., Java bytecode) into instructions that are understandable to the specific processor(s) of the processing core.

It is believed that processes taught by the discussion above can be practiced within various software environments such as, for example, object-oriented and non-object-oriented programming environments, Java based environments (such as a Java 2 Enterprise Edition (J2EE) environment or environments defined by other releases of the Java standard), or other environments (e.g., a .NET environment, a Windows/NT environment each provided by Microsoft Corporation).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A knowledge management system, comprising:
a data recognition engine to define metadata to be extracted from a plurality of data sources;
a data collection engine coupled to the data recognition engine to detect and extract the metadata from the plurality of data sources;
a data analysis engine coupled to the data recognition and data collection engines to link metadata collected from the data collection engine; and
a search engine coupled to the data analysis engine to receive output from the data analysis engine.

2. The system of claim 1, wherein the data recognition engine to receive user input to define the metadata to be extracted.

3. The system of claim 1, wherein the user input to provide rules by which the data collection engine operates.

4. The system of claim 1, wherein the user input to provide data collection rules by which the data collection engine operates.

5. The system of claim 1, wherein the data collection engine comprises one or more data collection agents to detect and extract the metadata from the data source.

6. The system of claim 5, wherein the one or more data collection agents to detect and extract the metadata from the data source in accordance with data collection rules.

7. The system of claim 6, wherein the one or more data collection agents is to provide data collection for a particular data source or type of data source.

8. The system of claim 7, wherein the data analysis engine to link metadata collected from the data collection engine in accordance with data analysis rules.

9. The system of claim 8, wherein the search engine to receive output from the data analysis engine based on input received by the data analysis engine.

10. An article of manufacture including program code, which, when executed by a machine, causes the machine to perform a method, comprising:
defining metadata to be extracted from a plurality of data sources;
detecting and extracting the metadata from the plurality of data sources;
linking the extracted metadata;
querying the linked extracted metadata; and
providing data to which the metadata relates in response to the querying.

11. The article of manufacture of claim 10, wherein the program code causes the machine to perform the method, further comprising receiving user input to define the metadata to be extracted.

12. The article of manufacture of claim 10, wherein the user input to provide rules by which to detect and extract data

13. The article of manufacture of claim 10, wherein the user input to provide data collection rules by which the data collection engine operates.

14. The article of manufacture of claim 10, wherein the program code causes the machine to perform the method, further comprising detecting and extracting the metadata from the data source.

15. The article of manufacture of claim 14, wherein the program code causes the machine to perform the method, further comprising detecting and extracting the metadata from a data source in accordance with data collection rules.

16. The article of manufacture of claim 15, the program code causes the machine to perform the method, further comprising providing data collection for a particular data source or type of data source.

17. The article of manufacture of claim 16, wherein the program code causes the machine to perform the method, further comprising linking metadata collected in accordance with data analysis rules.

18. The article of manufacture of claim 17, wherein the program code causes the machine to perform the method, further comprising to receive output from the data analysis engine based on input received by the data analysis engine.
